(19) United States
(12) Patent Application Publication
(10) Pub. No.: US 2024/0182826 A1
(43) Pub. Date: Jun. 6, 2024

(54) COMPOSITIONS AND METHODS FOR A BEVERAGE PRODUCT

(71) Applicant: Anthony Zolezzi, Rancho Santa Fe, CA (US)

(72) Inventor: Anthony Zolezzi, Rancho Santa Fe, CA (US)

(21) Appl. No.: 18/510,577

(22) Filed: Nov. 15, 2023

Related U.S. Application Data
(60) Provisional application No. 63/383,726, filed on Nov. 15, 2022.

(51) Int. Cl. C12G 1/02

(52) U.S. Cl. CPC C12G 1/02

(57) ABSTRACT

A method for producing a beverage is disclosed. The method includes adding a quantity of a first ingredient to a beverage solution where the first ingredient includes a measurable concentration of polyphenol.

### CROSS REFERENCE TO PRIOR APPLICATION

This application claims the benefit of U.S. Provisional Patent Application No. 63/383726, entitled as “COMPOSITONS AND METHODS FOR A BEVERAGE PRODUCT”, filed Nov. 15, 2022, which is incorporated by reference in its entirety.

### FIELD OF THE INVENTION

This disclosure relates to the fields of beverage production, alcoholic beverage production, and nutritional supplementation.

BACKGROUND

Resveratrol and other polyphenols are naturally occurring compounds in various plants. Some foods such as grapes contain resveratrol and other polyphenols. Wines produced from fermented grapes also contain a concentration of resveratrol. It is believed that consuming foods with resveratrol results in positive health benefits. However, the concentration of resveratrol in wine is relatively low where a 5 ounce glass of wine may contain at most a little over 1 mg of resveratrol. There is a need in the art for a beverage product with a higher concentration of resveratrol or other polyphenols.

### SUMMARY

An exemplary embodiment of the disclosed subject matter is a method for producing a beverage. The method includes adding a quantity of a first ingredient to a beverage solution, the first ingredient including a measurable concentration of resveratrol. The first ingredient may include a powder. The powder may include grape skins. The beverage solution may include a second ingredient that is fermented. The first ingredient may be added prior to fermentation of the second ingredient. The beverage solution may include a liqueur. The beverage solution may include wine. A resveratrol concentration of the beverage solution subsequent to adding the first ingredient may be between about 10 mg/L and about 2000 mg/L. A resveratrol concentration of the beverage solution subsequent to adding the first ingredient may be between about 10 mg/L and about 200 mg/L. A resveratrol concentration of the beverage solution subsequent to adding the first ingredient may be between about 200 mg/L and about 400 mg/L. A resveratrol concentration of the beverage solution subsequent to adding the first ingredient may be between about 400mg/L and about 600 mg/L. A resveratrol concentration of the beverage solution subsequent to adding the first ingredient may be between about 600mg/L and about 800 mg/L. A resveratrol concentration of the beverage solution subsequent to adding the first ingredient may be between about 600mg/L and about 800 mg/L. A resveratrol concentration of the beverage solution subsequent to adding the first ingredient may be between about 800mg/L and about 1000 mg/L. A resveratrol concentration of the beverage solution subsequent to adding the first ingredient may be between about 1000mg/L and about 1200 mg/L. A resveratrol concentration of the beverage solution subsequent to adding the first ingredient may be between about 1200mg/L and about 1400 mg/L. A resveratrol concentration of the beverage solution subsequent to adding the first ingredient may be between about 1400mg/L and about 1600 mg/L. A resveratrol concentration of the beverage solution subsequent to adding the first ingredient may be between about 1600mg/L and about 1800 mg/L. A resveratrol concentration of the beverage solution subsequent to adding the first ingredient may be between about 1800mg/L and about 2000mg/L.

Another general aspect is a beverage product. The beverage product includes a first ingredient, the first ingredient comprising a measurable concentration of resveratrol and a fermented product of a second ingredient. The first ingredient may include a powder. The powder may include grape skins. The first ingredient may be added prior to fermentation of the second ingredient. The beverage solution may include a liqueur. The beverage product may include wine. A resveratrol concentration of the beverage solution subsequent to adding the first ingredient may be between about 10 mg/L and about 2000 mg/L. A resveratrol concentration of the beverage product subsequent to adding the first ingredient may be between about 10 mg/L and about 2000 mg/L. A resveratrol concentration of the beverage product subsequent to adding the first ingredient may be between about 10 mg/L and about 200 mg/L. A resveratrol concentration of the beverage product subsequent to adding the first ingredient may be between about 200 mg/L and about 400 mg/L. A resveratrol concentration of the beverage product subsequent to adding the first ingredient may be between about 400 mg/L and about 600 mg/L. A resveratrol concentration of the beverage product subsequent to adding the first ingredient may be between about 600 mg/L and about 800 mg/L. A resveratrol concentration of the beverage product subsequent to adding the first ingredient may be between about 800 mg/L and about 1000 mg/L. A resveratrol concentration of the beverage product subsequent to adding the first ingredient may be between about 1000 mg/L and about 1200 mg/L. A resveratrol concentration of the beverage product subsequent to adding the first ingredient may be between about 1200 mg/L and about 1400 mg/L. A resveratrol concentration of the beverage product subsequent to adding the first ingredient may be between about 1400 mg/L and about 1600 mg/L. A resveratrol concentration of the beverage product subsequent to adding the first ingredient may be between about 1600 mg/L and about 1800 mg/L. A resveratrol concentration of the beverage product subsequent to adding the first ingredient may be between about 1800 mg/L and about 2000 mg/L.

An exemplary embodiment of the disclosed subject matter is a method for producing a beverage. The method includes adding a quantity of a first ingredient to a beverage solution, the first ingredient including a measurable concentration of polyphenol. The first ingredient may include a powder. The powder may include grape skins. The powder may include red wine powder. The beverage solution may include a second ingredient that is fermented. The first ingredient may be added prior to fermentation of the second ingredient. The beverage solution may include a liqueur. The beverage solution may include wine. A polyphenol concentration of the beverage solution subsequent to adding the first ingredient may be between about 10 mg/L and about 2000 mg/L. A polyphenol concentration of the beverage solution subsequent to adding the first ingredient may be between about 10mg/L and about 200 mg/L. A polyphenol concentration of the beverage solution subsequent to adding the first ingredient may be between about 200 mg/L and about 400 mg/L. A polyphenol concentration of the beverage solution subsequent to adding the first ingredient may be between about 400mg/L and about 600 mg/L. A polyphenol concentration of the beverage solution subsequent to adding the first ingredient may be between about 600mg/L and about 800 mg/L. A polyphenol concentration of the beverage solution subsequent to adding the first ingredient may be between about 600mg/L and about 800 mg/L. A polyphenol concentration of the beverage solution subsequent to adding the first ingredient may be between about 800 mg/L and about 1000 mg/L. A polyphenol concentration of the beverage solution subsequent to adding the first ingredient may be between about 1000mg/L and about 1200 mg/L. A polyphenol concentration of the beverage solution subsequent to adding the first ingredient may be between about 1200 mg/L and about 1400 mg/L. A polyphenol concentration of the beverage solution subsequent to adding the first ingredient may be between about 1400 mg/L and about 1600 mg/L. A polyphenol concentration of the beverage solution subsequent to adding the first ingredient may be between about 1600 mg/L and about 1800 mg/L. A polyphenol concentration of the beverage solution subsequent to adding the first ingredient may be between about 1800 mg/L and about 2000 mg/L.

Another general aspect is a beverage product. The beverage product includes a first ingredient, the first ingredient comprising a measurable concentration of polyphenol and a fermented product of a second ingredient. The first ingredient may include a powder. The powder may include grape skins. The first ingredient may be added prior to fermentation of the second ingredient. The beverage solution may include a liqueur. The beverage product may include wine. A polyphenol concentration of the beverage solution subsequent to adding the first ingredient may be between about 10 mg/L and about 2000 mg/L. A polyphenol concentration of the beverage product subsequent to adding the first ingredient may be between about 10 mg/L and about 2000 mg/L. A polyphenol concentration of the beverage product subsequent to adding the first ingredient may be between about 10 mg/L and about 200 mg/L. A polyphenol concentration of the beverage product subsequent to adding the first ingredient may be between about 200 mg/L and about 400 mg/L. A polyphenol concentration of the beverage product subsequent to adding the first ingredient may be between about 400 mg/L and about 600 mg/L. A polyphenol concentration of the beverage product subsequent to adding the first ingredient may be between about 600 mg/L and about 800 mg/L. A polyphenol concentration of the beverage product subsequent to adding the first ingredient may be between about 800 mg/L and about 1000 mg/L. A polyphenol concentration of the beverage product subsequent to adding the first ingredient may be between about 1000 mg/L and about 1200 mg/L. A polyphenol concentration of the beverage product subsequent to adding the first ingredient may be between about 1200 mg/L and about 1400 mg/L. A polyphenol concentration of the beverage product subsequent to adding the first ingredient may be between about 1400 mg/L and about 1600 mg/L. A polyphenol concentration of the beverage product subsequent to adding the first ingredient may be between about 1600 mg/L and about 1800 mg/L. A polyphenol concentration of the beverage product subsequent to adding the first ingredient may be between about 1800 mg/L and about 2000 mg/L.

### BRIEF DESCRIPTION OF THE DRAWINGS

FIG. 1 is a schematic diagram of a process for producing a fermented beverage that is supplemented with grape skin powder.

### DETAILED DESCRIPTION

The disclosed subject matter is a beverage that is supplemented with a food ingredient that includes a minimum amount of a polyphenol. Polyphenol refers to a class of organic compound comprising at least one phenolic ring. Various polyphenols are found in plant foods. Some examples of polyphenols that may be added to a beverage in embodiments of the disclosed subject matter include, but are not limited to, resveratrol, anthocyanins, flavonols, and phenolic acids.

Resveratrol has the molecular formula C₁₄H₁₂O₃. It has a trans and cis isomer with the following molecular structures:

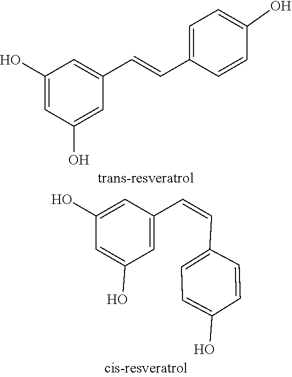

Both isomers of resveratrol are found in foods that contain resveratrol. The trans isomer is more stable and tends to be found in higher concentrations than the cis isomer in various foods. An exemplary embodiment includes all isomers and other forms of naturally occurring resveratrol.

Anthocyanins are another type of polyphenol found in plants. Some common types of anthocyanins have the following structure:

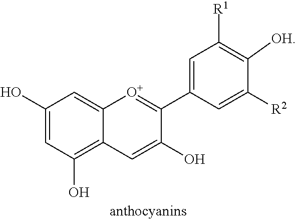

Examples of anthocyanins that may be used as a supplement in the disclosed subject matter include, but are not limited to:

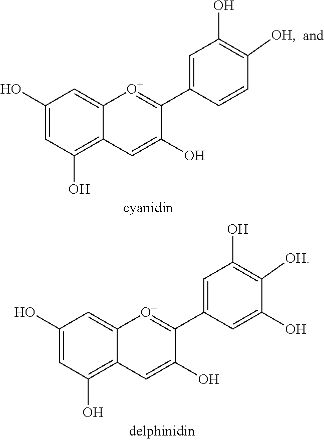 [SMILES: Oc1cc(O)c2cc(O)c(-c3ccc(O)c(O)c3)[o+]c2c1 ; Oc1cc(O)c2cc(O)c(-c3cc(O)c(O)c(O)c3)[o+]c2c1]

Flavonols have the following backbone structure:

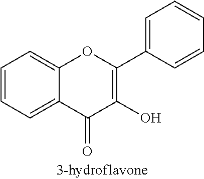 [SMILES: O=c1c(O)c(-c2ccccc2)oc2ccccc12]

Examples of flavonols that may be used as a supplement in the disclosed subject matter

include, but are not limited to:

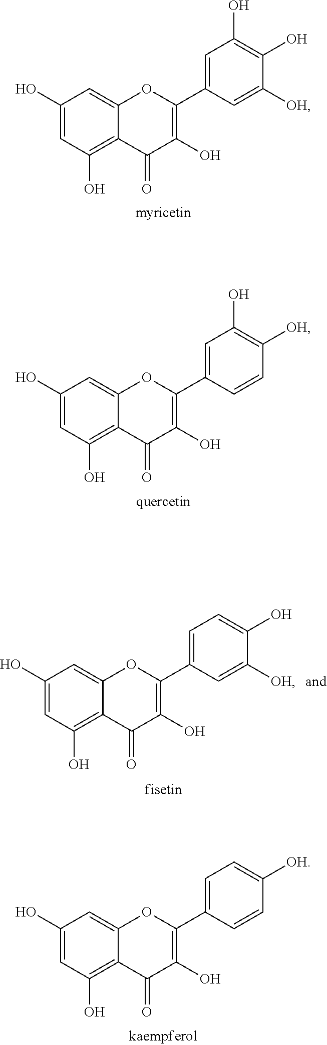 [SMILES: O=c1c(O)c(-c2cc(O)c(O)c(O)c2)oc2cc(O)cc(O)c12 ; O=c1c(O)c(-c2ccc(O)c(O)c2)oc2cc(O)cc(O)c12 ; O=c1c(O)c(-c2ccc(O)c(O)c2)oc2cc(O)cc(O)c12 ; "and" ; O=c1c(O)c(-c2ccc(O)cc2)oc2cc(O)cc(O)c12]

Examples of phenolic acids that may be used as a supplement in the disclosed subject matter include, but are not limited to:

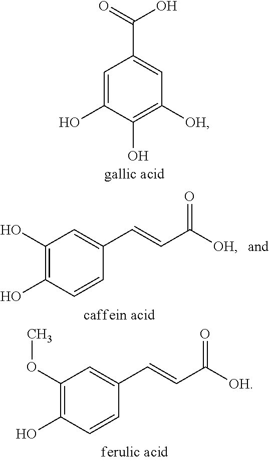

The disclosure of any polyphenol described herein may be combined or substituted with any other polyphenol. In various embodiments, the disclosure of any polyphenol used as a supplement, such as resveratrol, may be substituted with any combination of cyanidin, delphinidin, myricetin, quercetin, fisetin, kaempferol, gallic acid, caffein acid, ferulic acid, and resveratrol.

In an exemplary embodiment, the disclosed subject matter is a beverage that is supplemented with a food ingredient that includes a minimum amount of resveratrol. In an exemplary embodiment, the disclosed subject matter is a beverage that is supplemented with a food ingredient that includes a minimum amount of a polyphenol. In an exemplary embodiment, the disclosed subject matter is a beverage that is supplemented with a food ingredient that includes a minimum amount of a polyphenol such as resveratrol, an anthocyanin, a flavonol, a phenolic acid, or combination thereof. In an exemplary embodiment, the disclosed subject matter is a beverage that is supplemented with a food ingredient that includes a minimum amount of at least one of cyanidin, delphinidin, myricetin, quercetin, fisetin, kaempferol, gallic acid, caffein acid, ferulic acid, resveratrol, or any combination thereof. In various embodiments, the beverage may be a fermentation product. In an exemplary embodiment, an amount of resveratrol or other polyphenol is measured in a beverage solution prior to adding the food powder supplement. The amount of resveratrol or other phenol in the beverage solution determines the amount of the food ingredient to add to the beverage solution.

In various embodiments, a resveratrol or other polyphenol concentration of the food ingredient is measured prior to adding the food ingredient to the beverage solution. The measurement of resveratrol or other polyphenol in the beverage solution and/or the food ingredient prior to combining them predetermines a concentration of resveratrol or other polyphenol in the subsequent beverage product. Various analytical processes, such as high pressure liquid chromatography (HPLC) may be used to determine a concentration of resveratrol or other polyphenol in the beverage solution, the food powder, and/or the beverage product.

The beverage solution, as used herein, refers to a liquid food product prior to combining the liquid food product with a food ingredient. The food powder, as used herein, comprises any food product that is processed into a powdered form. In various embodiments the beverage solution is combined with a food powder. The beverage solution and food powder are combined to supplement the beverage solution to one or more nutritional elements of the food powder. In particular, it is anticipated that the food powder will increase a concentration of resveratrol or other polyphenol in the resulting beverage product. In various embodiments, the food powder comprises red wine powder.

The beverage product, as used herein, refers to a combination of the beverage solution and the food powder. In various embodiments, the food powder is dissolved into the beverage solution. In an exemplary embodiment, the food powder may include a plant product that contains resveratrol or other polyphenol. For example, the food powder may include grape skins, which are the outer layer of the fruit of the grapevine. In various embodiments, the food powder comprises red wine powder. The food powder may be added to the beverage solution before or during preparation of the beverage solution. For example, in cases where the beverage solution is wine, the food powder may be added to the fermented grape product before it is processed into wine or added to wine subsequent to fermentation.

The term “food product” as used herein refers to any natural food including but not limited to animal-based foods, plant-based foods, and fungi-based foods as well as the processed products thereof. An exemplary embodiment of the food product that is added to the beverage solution contains resveratrol or other polyphenol. The amount of the food product added to the beverage solution depends on the concentration of resveratrol or other polyphenol in the food product.

Food products that contain resveratrol or other polyphenol include but are not limited to blueberries, peanuts, lingonberry, lowbush, highbush, rabbiteye blueberry, bilberry, sparkleberry, deerberry, partridgeberry, soybeans, Japanese Knotweed, jackfruit skin, pistachios, cocoa powder, red currants, mulberries, cranberries, and plums. The various embodiments of the disclosed subject matter includes all variations of food products that contain resveratrol or other polyphenol.

In an exemplary embodiment, the beverage solution comprises a food product that is fermented or is being prepared for fermentation. The beverage solution may comprise various products of fermentation including beer and wine. In various embodiments the beverage solution may comprise distilled products of fermentation such as gin, rum, tequila, and vodka. In various embodiments the beverage solution may comprise a liqueur such as Amaretto, Cointreau, Kahhia, and Sambuca. The beverage solution may comprise any combinations thereof.

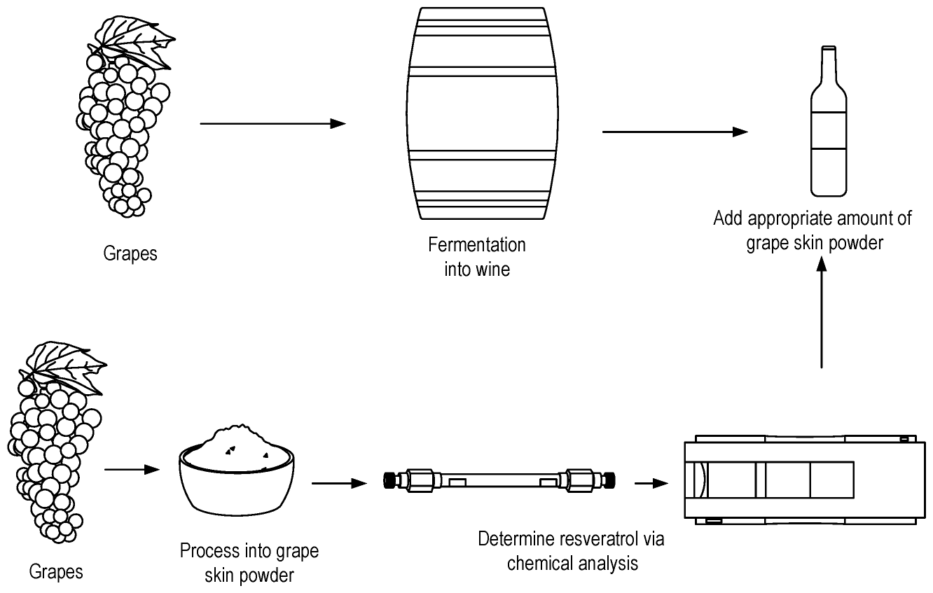

Referring to FIG. 1, FIG. 1 is a schematic diagram of a process for producing a fermented beverage that is supplemented with grape skin powder or red wine powder. As discussed above, the disclosed process for producing a beverage may be implemented with various beverages that include wine. The food ingredient added to the beverage may comprise various food products that include grape skin powder that is shown in FIG. 1.

In the exemplary embodiment shown in FIG. 1, both the beverage solution and the food ingredient, which is added to the beverage solution, are made from the same food product. For instance, the beverage solution can be made from grapes and the grape skin powder can be made from grapes. In various embodiments, red wine powder is substituted for the grape skin powder. In various embodiments both the beverage solution and the food ingredient added to the beverage solution may be obtained from the same source such as from the same vineyard.

In an exemplary embodiment of the disclosed subject matter, which is shown on the upper portion of FIG. 1, a quantity of grapes may be fermented into wine that is suitable for consumption. As shown on the bottom portion of FIG. 1, a quantity of grapes may be processed to separate grape skins from the rest of the grape. The grape skins may be tested to determine a resveratrol or other polyphenol concentration in the grape skins. In the exemplary embodiment shown in FIG. 1 the grape skins may be analyzed using various analytical methods such as high pressure liquid chromatography (HPLC).

In an exemplary embodiment, an amount of the grape skins may be determined based on the analysis. For example, if it is desired for the final beverage product to comprise 1000 mL of wine with a concentration of 30 mg of resveratrol or other polyphenol per liter of wine, and the wine contains an initial concentration of resveratrol or other polyphenol of 10 mg per 1000 mL, and the resveratrol or other polyphenol concentration and dried grape skins is determined to be 100 μg per gram, then 200 g of the grape skins would be added to the 1000 mL of wine to reach the desired concentration. In various embodiments, the beverage solution comprises a beverage other than wine. And in various embodiments, the food product, that is added to the beverage solution, may be a product other than grape skins.

In various embodiments the resveratrol concentration of the beverage product may be about 10 mg/L and about 2000 mg/L. The resveratrol concentration of the beverage product may be between about 5 mg/L and about 10 mg/L. The resveratrol concentration of the beverage product may be between about 10 mg/L and about 15 mg/L. The resveratrol concentration of the beverage product may be between about 15 mg/L and about 20 mg/L. The resveratrol concentration of the beverage product may be between about 20 mg/L and about 25 mg/L. The resveratrol concentration of the beverage product may be between about 25 mg/L and about 30 mg/L. The resveratrol concentration of the beverage product may be between about 30 mg/L and about 35 mg/L. The resveratrol concentration of the beverage product may be between about 35 mg/L and about 40 mg/L. The resveratrol concentration of the beverage product may be between about 40 mg/L and about 45 mg/L. The resveratrol concentration of the beverage product may be between about 45 mg/L and about 50 mg/L. The resveratrol concentration of the beverage product may be between about 50 mg/L and about 60 mg/L. The resveratrol concentration of the beverage product may be between about 60 mg/L and about 70 mg/L. The resveratrol concentration of the beverage product may be between about 70 mg/L and about 80 mg/L. The resveratrol concentration of the beverage product may be between about 80 mg/L and about 90 mg/L. The resveratrol concentration of the beverage product may be between about 90 mg/L and about 100 mg/L. The resveratrol concentration of the beverage product may be between about 100 mg/L and about 120 mg/L. The resveratrol concentration of the beverage product may be between about 120 mg/L and about 140 mg/L. The resveratrol concentration of the beverage product may be between about 140 mg/L and about 160 mg/L. The resveratrol concentration of the beverage product may be between about 160 mg/L and about 180 mg/L. The resveratrol concentration of the beverage product may be between about 180 mg/L and about 200 mg/L.

The resveratrol concentration of the beverage product may be between about 200 mg/L and about 220 mg/L. The resveratrol concentration of the beverage product may be between about 220 mg/L and about 240 mg/L. The resveratrol concentration of the beverage product may be between about 240 mg/L and about 260 mg/L. The resveratrol concentration of the beverage product may be between about 260 mg/L and about 280 mg/L. The resveratrol concentration of the beverage product may be between about 280 mg/L and about 300 mg/L. The resveratrol concentration of the beverage product may be between about 300 mg/L and about 350 mg/L. The resveratrol concentration of the beverage product may be between about 350 mg/L and about 400 mg/L The resveratrol concentration of the beverage product may be between about 400 mg/L and about 450 mg/L. The resveratrol concentration of the beverage product may be between about 450 mg/L and about 500 mg/L. The resveratrol concentration of the beverage product may be between about 500 mg/L and about 550 mg/L. The resveratrol concentration of the beverage product may be between about 550 mg/L and about 600 mg/L. The resveratrol concentration of the beverage product may be between about 600 mg/L and about 650 mg/L. The resveratrol concentration of the beverage product may be between about 650 mg/L and about 700 mg/L. The resveratrol concentration of the beverage product may be between about 700 mg/L and about 750 mg/L. The resveratrol concentration of the beverage product may be between about 750 mg/L and about 800 mg/L. The resveratrol concentration of the beverage product may be between about 800 mg/L and about 850 mg/L. The resveratrol concentration of the beverage product may be between about 850 mg/L and about 900 mg/L. The resveratrol concentration of the beverage product may be between about 850 mg/L and about 900 mg/L. The resveratrol concentration of the beverage product may be between about 900 mg/L and about 950 mg/L. The resveratrol concentration of the beverage product may be between about 950 mg/L and about 1000 mg/L.

The resveratrol concentration of the beverage product may be between about 1000 mg/L and about 1050 mg/L. The resveratrol concentration of the beverage product may be between about 1050 mg/L and about 1100 mg/L. The resveratrol concentration of the beverage product may be between about 1100 mg/L and about 1150 mg/L. The resveratrol concentration of the beverage product may be between about 1150 mg/L and about 1200 mg/L. The resveratrol concentration of the beverage product may be between about 1200 mg/L and about 1250 mg/L. The resveratrol concentration of the beverage product may be between about 1250 mg/L and about 1300 mg/L. The resveratrol concentration of the beverage product may be between about 1300 mg/L and about 1350 mg/L. The resveratrol concentration of the beverage product may be between about 1350 mg/L and about 1400 mg/L. The resveratrol concentration of the beverage product may be between about 1400 mg/L and about 1450 mg/L. The resveratrol concentration of the beverage product may be between about 1450 mg/L and about 1500 mg/L. The resveratrol concentration of the beverage product may be between about 1500 mg/L and about 1550 mg/L. The resveratrol concentration of the beverage product may be between about 1550 mg/L and about 1600 mg/L. The resveratrol concentration of the beverage product may be between about 1650 mg/L and about 1700 mg/L. The resveratrol concentration of the beverage product may be between about 1700 mg/L and about 1750 mg/L. The resveratrol concentration of the beverage product may be between about 1750 mg/L and about 1800 mg/L. The resveratrol concentration of the beverage product may be between about 1800 mg/L and about 1850 mg/L. The resveratrol concentration of the beverage product may be between about 1850 mg/L and about 1900 mg/L. The resveratrol concentration of the beverage product may be between about 1900 mg/L and about 1950 mg/L. The resveratrol concentration of the beverage product may be between about 1950 mg/L and about 2000 mg/L.

In various embodiments the resveratrol concentration of the beverage product may be between about 10 mg/L and about 200 mg/L. The resveratrol concentration of the beverage product may be between about 200 mg/L and about 400 mg/L. The resveratrol concentration of the beverage product may be between about 400 mg/L and about 600 mg/L. The resveratrol concentration of the beverage product may be between about 600 mg/L and about 800 mg/L. The resveratrol concentration of the beverage product may be between about 800 mg/L and about 1000 mg/L. The resveratrol concentration of the beverage product may be between about 1000 mg/L and about 1200 mg/L. The resveratrol concentration of the beverage product may be between about 1200 mg/L and about 1400 mg/L. The resveratrol concentration of the beverage product may be between about 1400 mg/L and about 1600 mg/L. The resveratrol concentration of the beverage product may be between about 1600 mg/L and about 1800 mg/L. The resveratrol concentration of the beverage product may be between about 1800 mg/L and about 2000 mg/L.

In various embodiments the resveratrol concentration of the beverage product may be about 10 mg/L and about 2000 mg/L. The resveratrol concentration of the beverage product may be between about 5 mg/L and about 10 mg/L. The resveratrol concentration of the beverage product may be between about 10 mg/L and about 15 mg/L. The resveratrol concentration of the beverage product may be between about 15 mg/L and about 20 mg/L. The resveratrol concentration of the beverage product may be between about 20 mg/L and about 25 mg/L. The resveratrol concentration of the beverage product may be between about 25 mg/L and about 30 mg/L. The resveratrol concentration of the beverage product may be between about 30 mg/L and about 35 mg/L. The resveratrol concentration of the beverage product may be between about 35 mg/L and about 40 mg/L. The resveratrol concentration of the beverage product may be between about 40 mg/L and about 45 mg/L. The resveratrol concentration of the beverage product may be between about 45 mg/L and about 50 mg/L. The resveratrol concentration of the beverage product may be between about 50 mg/L and about 60 mg/L. The resveratrol concentration of the beverage product may be between about 60 mg/L and about 70 mg/L. The resveratrol concentration of the beverage product may be between about 70 mg/L and about 80 mg/L. The resveratrol concentration of the beverage product may be between about 80 mg/L and about 90 mg/L. The resveratrol concentration of the beverage product may be between about 90 mg/L and about 100 mg/L. The resveratrol concentration of the beverage product may be between about 100 mg/L and about 120 mg/L. The resveratrol concentration of the beverage product may be between about 120 mg/L and about 140 mg/L. The resveratrol concentration of the beverage product may be between about 140 mg/L and about 160 mg/L. The resveratrol concentration of the beverage product may be between about 160 mg/L and about 180 mg/L. The resveratrol concentration of the beverage product may be between about 180 mg/L and about 200 mg/L.

The polyphenol concentration of the beverage product may be between about 200 mg/L and about 220 mg/L. The polyphenol concentration of the beverage product may be between about 220 mg/L and about 240 mg/L. The polyphenol concentration of the beverage product may be between about 240 mg/L and about 260 mg/L. The polyphenol concentration of the beverage product may be between about 260 mg/L and about 280 mg/L. The polyphenol concentration of the beverage product may be between about 280 mg/L and about 300 mg/L. The polyphenol concentration of the beverage product may be between about 300 mg/L and about 350 mg/L. The polyphenol concentration of the beverage product may be between about 350 mg/L and about 400 mg/L The polyphenol concentration of the beverage product may be between about 400 mg/L and about 450 mg/L. The polyphenol concentration of the beverage product may be between about 450 mg/L and about 500 mg/L. The polyphenol concentration of the beverage product may be between about 500 mg/L and about 550 mg/L. The polyphenol concentration of the beverage product may be between about 550 mg/L and about 600 mg/L. The polyphenol concentration of the beverage product may be between about 600 mg/L and about 650 mg/L. The polyphenol concentration of the beverage product may be between about 650 mg/L and about 700 mg/L. The polyphenol concentration of the beverage product may be between about 700 mg/L and about 750 mg/L. The polyphenol concentration of the beverage product may be between about 750 mg/L and about 800 mg/L. The polyphenol concentration of the beverage product may be between about 800 mg/L and about 850 mg/L. The polyphenol concentration of the beverage product may be between about 850 mg/L and about 900 mg/L. The polyphenol concentration of the beverage product may be between about 850 mg/L and about 900 mg/L. The polyphenol concentration of the beverage product may be between about 900 mg/L and about 950 mg/L. The polyphenol concentration of the beverage product may be between about 950 mg/L and about 1000 mg/L.

The polyphenol concentration of the beverage product may be between about 1000 mg/L and about 1050 mg/L. The polyphenol concentration of the beverage product may be between about 1050 mg/L and about 1100 mg/L. The polyphenol concentration of the beverage product may be between about 1100 mg/L and about 1150 mg/L. The polyphenol concentration of the beverage product may be between about 1150 mg/L and about 1200 mg/L. The polyphenol concentration of the beverage product may be between about 1200 mg/L and about 1250 mg/L. The polyphenol concentration of the beverage product may be between about 1250 mg/L and about 1300 mg/L. The polyphenol concentration of the beverage product may be between about 1300 mg/L and about 1350 mg/L. The polyphenol concentration of the beverage product may be between about 1350 mg/L and about 1400 mg/L. The polyphenol concentration of the beverage product may be between about 1400 mg/L and about 1450 mg/L. The polyphenol concentration of the beverage product may be between about 1450 mg/L and about 1500 mg/L. The polyphenol concentration of the beverage product may be between about 1500 mg/L and about 1550 mg/L. The polyphenol concentration of the beverage product may be between about 1550 mg/L and about 1600 mg/L. The polyphenol concentration of the beverage product may be between about 1650 mg/L and about 1700 mg/L. The polyphenol concentration of the beverage product may be between about 1700 mg/L and about 1750 mg/L. The polyphenol concentration of the beverage product may be between about 1750 mg/L and about 1800 mg/L. The polyphenol concentration of the beverage product may be between about 1800 mg/L and about 1850 mg/L. The polyphenol concentration of the beverage product may be between about 1850 mg/L and about 1900 mg/L. The polyphenol concentration of the beverage product may be between about 1900 mg/L and about 1950 mg/L. The polyphenol concentration of the beverage product may be between about 1950 mg/L and about 2000 mg/L.

In various embodiments the polyphenol concentration of the beverage product may be between about 10 mg/L and about 200 mg/L. The polyphenol concentration of the beverage product may be between about 200 mg/L and about 400 mg/L. The polyphenol concentration of the beverage product may be between about 400 mg/L and about 600 mg/L. The polyphenol concentration of the beverage product may be between about 600 mg/L and about 800 mg/L. The polyphenol concentration of the beverage product may be between about 800 mg/L and about 1000 mg/L. The polyphenol concentration of the beverage product may be between about 1000 mg/L and about 1200 mg/L. The polyphenol concentration of the beverage product may be between about 1200 mg/L and about 1400 mg/L. The polyphenol concentration of the beverage product may be between about 1400 mg/L and about 1600 mg/L. The polyphenol concentration of the beverage product may be between about 1600 mg/L and about 1800 mg/L. The resveratrol concentration of the beverage product may be between about 1800 mg/L and about 2000 mg/L.

Many variations of the disclosed subject matter may be made and practices according to the embodiments described herein. The many variations are intended to be included within the scope of this disclosure, including combinations of variations. Any terminology used herein should not be construed as restricting the features or aspects of the disclosed subject matter. The scope should instead be construed in accordance with the appended claims.

1. A method for producing a beverage, the method comprising:
adding a quantity of a first ingredient to a beverage solution, the first ingredient comprising a measurable concentration of polyphenol.

2. The method of claim 1, wherein the first ingredient comprises a powder.

3. The method of claim 2, wherein the powder comprises grape skins.

4. The method of claim 1, wherein the beverage solution comprises a second ingredient that is fermented.

5. The method of claim 4, wherein the first ingredient is added prior to fermentation of the second ingredient.

6. The method of claim 1, wherein the polyphenol is selected from of one or more of the group consisting of cyanidin, delphinidin, myricetin, quercetin, fisetin, kaempferol, gallic acid, caffein acid, ferulic acid, and resveratrol.

7. The method of claim 1, wherein the beverage solution comprises wine.

8. The method of claim 7, wherein a polyphenol concentration of the beverage solution subsequent to the adding the first ingredient is between about 10 mg/L and about 2000 mg/L.

9. The method of claim 7, wherein a polyphenol concentration of the beverage solution subsequent to adding the first ingredient is between about 10 mg/L and about 200 mg/L.

10. The method of claim 7, wherein a polyphenol concentration of the beverage solution subsequent to adding the first ingredient is between about 200 mg/L and about 2000 mg/L.

11. A beverage product, the beverage product comprising:
a first ingredient, the first ingredient comprising a measurable concentration of polyphenol; and
a fermented product of a second ingredient.

12. The beverage product of claim 11, wherein the first ingredient comprises a powder.

13. The beverage product of claim 12, wherein the powder comprises red wine powder.

14. The beverage product of claim 11, wherein the first ingredient is added prior to fermentation of the second ingredient.

15. The beverage product of claim 11, wherein the polyphenol is selected from of one or more of the group consisting of cyanidin, delphinidin, myricetin, quercetin, fisetin, kaempferol, gallic acid, caffein acid, ferulic acid, and resveratrol.

16. The beverage product of claim 11, wherein the beverage product comprises wine.

17. The beverage product of claim 16, wherein a polyphenol concentration of the beverage product subsequent to adding the first ingredient is between about 10 mg/L and about 2000 mg/L.

18. The beverage product of claim 16, wherein a polyphenol concentration of the beverage product subsequent to adding the first ingredient is between about 10 mg/L and about 200 mg/L.

19. The beverage product of claim 16, wherein a polyphenol concentration of the beverage product subsequent to adding the first ingredient is between about 200 mg/L and about 1000 mg/L.

20. The beverage product of claim 16, wherein a polyphenol concentration of the beverage product subsequent to adding the first ingredient is between about 1000 mg/L and about 2000 mg/L.
